(19) United States
(12) Patent Application Publication
(10) Pub. No.: US 2004/0052232 A1
(43) Pub. Date: Mar. 18, 2004

(54) Method and apparatus for detecting the presence of a wireless local area network using a position location system

(76) Inventors: Kumar Ramaswamy, Plainsboro, NJ (US); Louis Robert Litwin JR., Plainsboro, NJ (US); Paul Gothard Knutson, Lawrenceville, NJ (US); Wen Gao, Plainsboro, NJ (US); Charles Chuanming Wang, Jamison, PA (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/243,905

(22) Filed: Sep. 13, 2002

(51) Int. Cl. H04Q 7/24; H04Q 7/00

(52) U.S. Cl. 370/338; 370/328

(57) ABSTRACT

A method and apparatus for detecting the presence of a wireless local area network (WLAN) (104) determines a position of a mobile device (110) using a position location system (114), receives a position of a WLAN (104) from a location database(112), and determines whether the mobile device (110) is within a service area (108) of the WLAN (104) in response to the position of the mobile device (110) and the position of the WLAN (104).

### CROSS-REFERENCE TO RELATED APPLICATIONS

This patent application is related to simultaneously filed U.S. patent application Ser. Nos. ______ (Attorney Docket No. PU020076), and ______ (Attorney Docket No. PU020078), which patent applications are incorporated herein by reference in their respective entireties.

### BACKGROUND OF THE INVENTION

1. Field of the Invention

The present invention generally relates to communication systems and, more particularly, to a method and apparatus for detecting the presence of a wireless local area network.

2. Description of the Related Art

Presently, 2.5 generation (2.5G) and third generation (3G) cellular networks can provide wireless data service, such as wireless Internet service, having data rates up to 2 Mbps. On the other hand, wireless local area networks (WLANs), such as IEEE 802.11a, IEEE 802.11b, and HiperLAN/2 wireless networks, for example, can provide data service with rates higher than 10 Mbps. WLAN service is also typically cheaper to implement than cellular service due to the use of unlicensed frequency bands by WLANs. As such, it is desirable to switch from cellular service to WLAN service when a mobile device is within the service area of a WLAN. Switching between cellular service and WLAN service can provide for optimal utilization of the available spectrum, and can reduce the burden on cellular networks during times of peak activity.

Mobile devices typically have limited power resources. Continuously checking for the presence of a WLAN by powering up a complete WLAN subsystem can result in considerable power drain. Thus, there is a need to minimize power used by mobile devices capable of communicating with multiple types of wireless networks, such as cellular and WLAN networks.

### SUMMARY OF THE INVENTION

The present invention is a method and apparatus for detecting the presence of a wireless local area network (WLAN). Specifically, the present invention determines a position of a mobile device using a position location system. The present invention also receives a position of a WLAN from a location database. The present invention then determines whether the mobile device is within a service area of the WLAN in response to the position of the mobile device and the position of the WLAN. In one embodiment, the mobile device activates WLAN circuitry when the mobile device is within the service area of the WLAN. The mobile device then transfers communications from the wireless communication system to the WLAN.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a communication system in accordance with the present invention;

FIG. 2 depicts a high-level block diagram showing one embodiment of a mobile device in accordance with the present invention;

FIG. 3 depicts a flow diagram showing one embodiment of a method for detecting the presence of a WLAN; and

FIG. 4 depicts a flow diagram showing one embodiment of a method for detecting the absence of a WLAN.

### DETAILED DESCRIPTION

The present invention is a method and apparatus for detecting the presence of a wireless local area network (WLAN). The present invention will be described within the context of transferring communications in a mobile device from a cellular telephone network to a WLAN when the mobile device is located within the service area of the WLAN. Those skilled in the art, however, will appreciate that the present invention can be advantageously employed in any communication device that is capable of communicating with a WLAN. Thus, the present invention has broad applicability beyond the communication systems described herein.

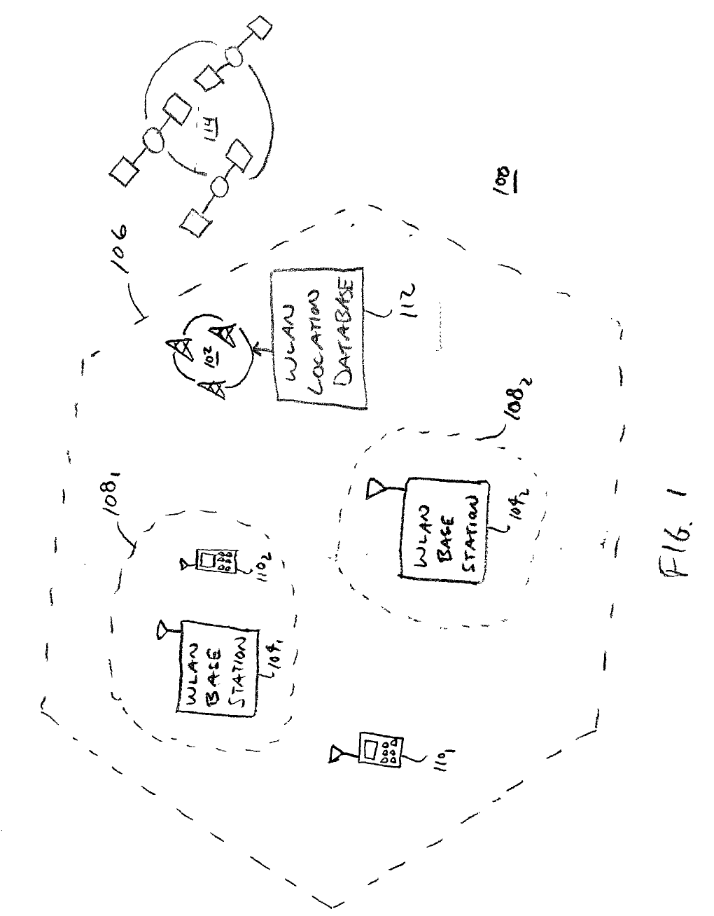

FIG. 1 depicts a communication system 100 in accordance with the present invention. The communication system 100 comprises a wireless communication network 102, a plurality of WLAN access points 104 (e.g., WLAN access points 104₁ and 104₂), a WLAN location database 112, a position location system 114, and a plurality of mobile devices 110 (e.g., mobile devices 110₁ and 110₂). The wireless communication network 102 provides service to mobile devices 110 located within a service area 106 (e.g., mobile devices 110₁ and 110₂). For example, the wireless communication network 102 can comprise a cellular telephone network providing voice and/or data services to mobile devices 110 within the service area 106.

The WLAN access points 104₁ and 104₂ provide service to mobile devices 110 located within service areas 108₁ and 108₂, respectively (e.g., mobile device 110₂ located within service area 108₁). For example, the WLAN access points 104 can comprise IEEE 802.11b WLAN access points providing voice and/or data services to mobile devices 110 within the service areas 108. The location of each of the WLAN access points 104 is stored within the WLAN location database 112. For example, the WLAN location database 112 can store the coordinates (e.g., longitude and latitude) for each of the WLAN access points 104 along with the extent of the service areas 108. The communication system 100 is illustratively shown having non-overlapping service areas 108 corresponding to the WLAN access points 104 that are located with the service area 106. Other arrangements can be used with the present invention, such as overlapping service areas 108.

The position location system 114 illustratively comprises a satellite positioning system, such as the Global Positioning System (GPS) or the Global Navigation Satellite System (GLONASS). For example, the position location system 114 can comprise an assisted GPS system (AGPS), where the wireless communication system 102 aids in computing position. Such AGPS systems are well known in the art. Although the present invention is described herein as being used with a satellite positioning system, those skilled in the art will appreciate that other position location systems can be used, such as the Long Range Aid to Navigation (LORAN) positioning system.

In accordance with the present invention, each of the mobile devices 110 is capable of detecting the presence of a WLAN. As described below, the present invention can determine the position of each of the mobile devices 110 using the position location system 114. Based on the current position of a given mobile device 110ᵢ and positions of the WLAN access points 104 stored in the WLAN location database 112, the mobile device 110ᵢ can determine the presence of a WLAN. As such, the present invention enables each of the mobile devices 110 to communicate with one or more of the WLAN access points 104, rather than the wireless communication network 102, when the mobile device 110 is located within the service areas 108. For example, mobile device 110₂, which is located within service area 108₁, is capable of communicating with WLAN access point 104₁ and wireless communication system 102. Thus, mobile device 110₂ can transfer communications between WLAN access point 104₁ and wireless communication system 102 as desired. Mobile device 110₁, however, will continue to communicate with the wireless communication system 102 until the mobile device 1101 moves within one or more of the service areas 108 of the WLAN access points 104.

The decision to switch between the wireless communication system 102 and the WLAN can be made at the mobile device 110 or by the intelligence in the wireless communication system 102. For the wireless communication system 102 to make the decision, the wireless communication system 102 requires precise knowledge of the location of the mobile device 110 and the location of the WLAN access points 104. The location of the mobile device 110 can be obtained precisely, for example, by using a Global Positioning System (GPS) receiver in the mobile device 110, and sending the coordinates to the wireless communication system 102 as described in more detail below. Alternatively, the decision to switch can be made by the mobile device 110, for example, by scanning for the presence of a WLAN. Such systems are described in commonly assigned patent application Ser. Nos. ______ (Attorney Docket No. PU020076) and ______ (Attorney Docket No. ______ PU020078), which are incorporated by reference in their respective entireties.

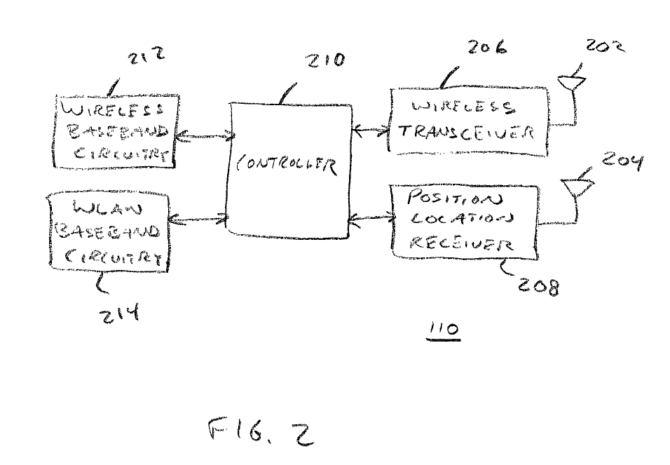

FIG. 2 depicts a high-level block diagram showing one embodiment of a mobile device 110 in accordance with the present invention. The mobile device 110 comprises a wireless transceiver 206 coupled to an antenna 202, a position location receiver 208 coupled to an antenna 204, a controller 210, wireless baseband circuitry 212, and WLAN baseband circuitry 214. Wireless baseband circuitry 212 processes signals associated with a wireless communication system, such as cellular telephone signals. WLAN baseband circuitry 214 processes signals associated with a WLAN, such as IEEE 802.11b WLAN signals. Wireless transceiver 206 transmits and receives radio frequency (RF) signals that are processed by the wireless baseband circuitry 212 or the WLAN baseband circuitry 214 through the controller 210. The position location receiver 208 receives signals from a position location system, such as GPS signals. For example, the mobile device 110 can comprise a cellular telephone having a GPS receiver (e.g., a cellular telephone capable of enhanced 911 services) and a WLAN plug-in card (e.g., a personal computer memory card internal association (PCMCIA) plug-in card). In another example, the mobile device 110 can comprise a personal digital assistant (PDA) or a laptop computer with a WLAN and GPS plug-in cards.

The controller 210 can comprise a processor coupled between the wireless baseband circuitry 212, the WLAN baseband circuitry 214, the wireless transceiver 206, and the position location receiver 208. In this embodiment, the controller 210 is programmed to perform various control functions in accordance with the present invention. Those skilled in the art will appreciate, however, that the invention can be implemented in hardware, for example, as an application specific integrated circuit (ASIC). As such, the process steps described herein are intended to be broadly interpreted as being equivalently performed by software, hardware, or a combination thereof. Furthermore, although the controller 210 is depicted as a separate functional block, those skilled in the art will appreciate that the wireless baseband circuitry 212 and/or the WLAN baseband circuitry 214 can be adapted to perform the functions of the controller 210.

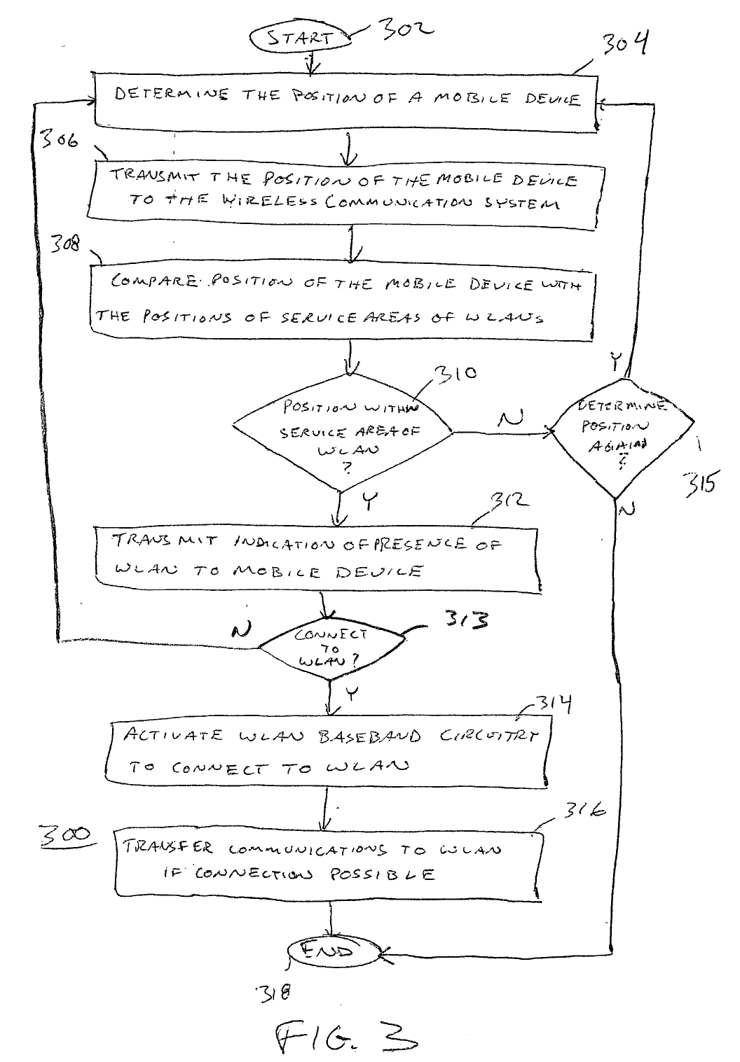

FIG. 3 depicts a flow diagram showing one embodiment of a method 300 for detecting the presence of a WLAN. The method 300 can be best understood with simultaneous reference to FIGS. 1 and 2. The method 300 begins at step 302, and proceeds to step 304, where the position of a mobile device (e.g., mobile device 110₂) is determined using the position location system 114. The mobile device 110 can calculate position solely from GPS signals transmitted by the position location system 114, or with the addition of aiding information from the wireless communication system 102 (e.g., the position location system 114 comprises an AGPS system). At step 306, the mobile device 110 transmits the calculated position to the wireless communication system 102. The mobile device 110 can transmit position only during a data communication between the mobile device 110 and the wireless communication system 102. Alternatively, the mobile device 110 can initiate a communication with the wireless communication system 102 to transmit position thereto.

At step 308, the position of the mobile device 110 is compared to positions of services areas 108 corresponding to WLAN access points 104. As described above, the coordinates of WLAN access points 104 are stored within the WLAN location database 112. At step 310, the wireless communication system 102 determines whether the mobile device 110 is within one or more of the service areas 108. If the mobile device 110 is within one or more of the service areas 108, the method 300 proceeds to step 312. Otherwise, the method proceeds to step 315.

At step 315, the mobile device determines whether to calculate position again. If the mobile device 110 is to calculate position again, the method 400 returns to step 304. The mobile device 110 can calculate position periodically, in response to a specific request from a user, or in response to a data communication between the mobile device and wireless communication system 102. If the mobile device 100 is not to calculate position again, the method 400 proceeds to end step 318.

At step 312, the wireless communication system 102 transmits an indication of the presence of a WLAN to the mobile device 110. In the present example, the wireless communication system 102 would send an indication to the mobile device 110₂ that the mobile device 110₂ is within the service area 108₁ of the WLAN access point 104₁. Again, the wireless communication system 102 can either send the indication during a data communication between the mobile device 110 and the wireless communication system 102, or can send the indication by initiating a data communication with the mobile device 110. At step 313, the mobile device 110 determines whether to connect to the WLAN. If the mobile device 110 is to connect to the WLAN, the method 300 proceeds to step 314. If the mobile device 110 determines not to connect to the WLAN, the method 300 proceeds to step 304. For example, the mobile device 110 may determine not to connect to the WLAN if the signal quality received from the WLAN is below a predetermined threshold.

At step 314, the mobile device 110 activates the WLAN baseband circuitry 214 to connect with the WLAN. At step 316, the mobile device 110 transfers communications therein to the WLAN if connection to the WLAN is possible. Hitherto, the mobile device 110 has been communicating with the wireless communication system 102. The method 300 ends at step 318.

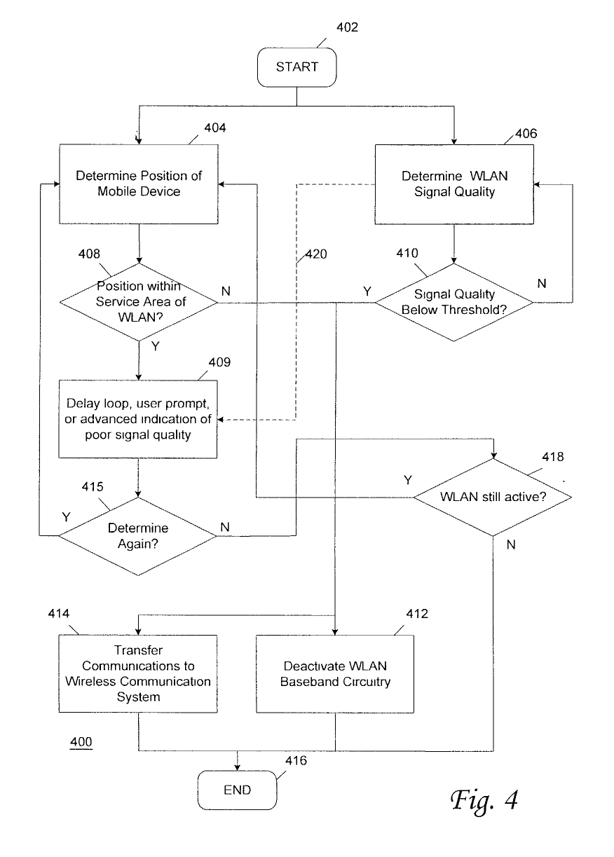

FIG. 4 depicts a flow diagram showing one embodiment of a method 400 for detecting the absence of a WLAN. Again, the method 400 can best be understood with simultaneous reference to FIGS. 1 and 2. In the present example, it is assumed that one of the mobile devices 110 (e.g., mobile device 110₁) has been communicating with a WLAN. The method 400 begins at step 402, and proceeds to steps 404 and 406. At step 404, the position of the mobile device 110 is determined using the position location system 114. At step 408, the position of the mobile device 110 is compared to the service area of the WLAN. If the position is within one or more of the service areas 108 corresponding to the WLAN access points 104, the method 400 proceeds to step 409. If the position is outside of the service areas 108, the method 400 proceeds to steps 412 and 414.

At step 409, a number of methods can be initialized to determine when to again check the position of the mobile device. A delay can be initialized, after which a position check can be repeated, the user could prompt a position check, or, based on increasing error rate, a position check could be prompted by the WLAN signal quality measurements, indicated by dashed path 420. Any of these methods can be used to trigger the reexamination of the mobile device's position.

At step 415, the mobile device 110 determines whether to calculate position again. If the mobile device 110 is to check position again, the method returns to step 404. The mobile device 110 can calculate position periodically, in response to a specific request from a user, in response to a data communication between the mobile device 110 and the WLAN, or in response to increasing error rates. While the mobile device 110 is waiting to check position again, the mobile device 110 checks whether the WLAN link is still active at step 418. For example, the WLAN link could have been deactivated in response to a parallel process started at step 406. If the WLAN is still active, the method 400 proceeds to step 404. Otherwise, the method 400 proceeds to end step 416.

At step 406, the mobile device 110 determines the quality of the signal received by the WLAN. As the mobile device 110 moves away from one of the WLAN access points 104, the quality of the signal will be decreasing. At step 410, the mobile device 110 determines whether the quality of signal is below a predetermined threshold. If the quality of signal is above the predetermined threshold, (i.e., adequate quality of signal), the method 400 continues to monitor signal quality. If the quality of signal is below the predetermined threshold, the method 400 proceeds to parallel steps 412 and 414. If the quality of signal is marginal, a signal 420 can be sent to trigger a check of position. The test for signal quality 406 can have some hysteresis—it should take several packet failures before determining that the signal quality is below threshold.

At step 412, the mobile device 110 deactivates the WLAN baseband circuitry 214. At step 414, the mobile device 110 transfers communications therein to the wireless communication system 102. In the present example, the mobile device 110₁ would determine position to be outside of the service areas 108, or would sense a decrease in quality of signal from one or more of the WLAN bases stations 104. Hitherto, the mobile device 110₁ has been communicating with the WLAN. Thus, the mobile device 110₁ would transfer communications therein to the wireless communication network 102. The method ends at step 416.

While the foregoing is directed to the preferred embodiment of the present invention, other and further embodiments of the invention may be devised without departing from the basic scope thereof, and the scope thereof is determined by the claims that follow.

What is claimed:

1. A method, comprising:
determining (304) a position of a mobile device using a position location system; and
receiving (308) a position of a wireless local area network (WLAN) from a location database;
determining (310) whether the mobile device is within a service area of the WLAN in response to the position of the mobile device and the position of the WLAN.

2. The method of claim 1, further comprising:
activating (314) WLAN circuitry in the mobile device when the mobile device is within the service area of the WLAN; and
deactivating (412) the WLAN circuitry in the mobile device when the mobile device is outside of the service area of the WLAN.

3. The method of claim 2, further comprising:
transferring (316) communications in the mobile device from the wireless communication system to the WLAN when the mobile device is within the service area of the WLAN; and
transferring (414) communications in the mobile device from the WLAN to the wireless communication system when the mobile device is outside of the service area of the WLAN.

4. The method of claim 3, wherein the wireless communication system is a cellular telephone network.

5. The method of claim 2, wherein the step of deactivating comprises at least one of:
disabling (408) the WLAN circuitry when the position of the mobile device is determined to be outside of the service area of the WLAN; and
disabling (410) the WLAN circuitry in response to a decrease in signal quality received by the WLAN.

6. The method of claim 1, further comprising:
transmitting (306) the position of the mobile device to the wireless communication system;
comparing (308) the position of the mobile device to the position of the service area of the WLAN; and
transmitting (312) an indication to the mobile device when the mobile device is within the service area of the WLAN.

7. The method of claim 6, wherein the step of transmitting the position of the mobile device comprises at least one of:
sending (315) the position to the wireless communication system only when the mobile device is communicating therewith;
sending (315) the position to the wireless communication system periodically; and
sending (315) the position to the wireless communication system in response to a specific request.

8. The method of claim 6, wherein the step of transmitting an indication comprises:
sending (315) the indication to the mobile device only when the mobile device is communicating with the wireless communication system.

9. An apparatus, comprising:
a position location receiver (204) for determining a position of a mobile device (110); and
a controller (210) for receiving a position of a wireless local area network (WLAN) (104) from a location database (112), and for determining whether the mobile device (110) is within a service area (108) of the WLAN (104) in response to the position of the mobile device (110) and the position of the WLAN (104).

10. The apparatus of claim 9, wherein the controller (210) is further configured to:
activate WLAN circuitry (214) in the mobile device (110) when the mobile device(110) is within the service area (108) of the WLAN (104); and
deactivate the WLAN circuitry (214) in the mobile device (110) when the mobile device (110) is outside of the service area (108) of the WLAN (104).

11. The apparatus of claim 10, wherein the controller (210) is further configured to:
transfer communications in the mobile device (110) from a wireless communication system (102) to the WLAN (104) when the mobile device (110) is within the service area (108) of the WLAN (104); and
transfer communications in the mobile device (110) from the WLAN (104) to the wireless communication system (102) when the mobile device (110) is outside of the service area (108) of the WLAN (104).

12. The apparatus of claim 11, wherein the wireless communication system (102) is a cellular telephone network.

13. The apparatus of claim 10, wherein the controller (210) deactivates the WLAN circuitry (214) by at least one of:
disabling the WLAN circuitry (214) when the position of the mobile device (110) is determined to be outside of the service area (108) of the WLAN (104); and
disabling the WLAN circuitry (214) in response to a decrease in signal quality received from the WLAN (104).

14. The apparatus of claim 9, wherein the controller (210) is further configured to:
transmit the position of the mobile device (110) to the wireless communication system (102); and
receive an indication from the wireless communication system (102) when the mobile device (110) is within the service area (108) of the WLAN (104).

15. The apparatus of claim 14, wherein the controller (210) transmits the position of the mobile device (110) by at least one of:
sending the position to the wireless communication system (102) only when the mobile device (110) is communicating therewith;
sending the position to the wireless communication system (102) periodically; and
sending the position to the wireless communication system (102) in response to a specific request.

16. The apparatus of claim 14, wherein the controller (210) receives an indication from the wireless communication system (102) only when the mobile device (110) is communicating data to the wireless communication system (102).

17. A communication system, comprising:
a wireless communication system (102) for communicating with a mobile device (110);
a wireless local area network (WLAN) (104) for communicating with a mobile device (110), the WLAN (104) including at least one access point having a respective at least one service area (108);
a WLAN location database (112) for storing the position of the at least one access point;
a position location receiver (208) within the mobile device (110) for determining the position of the mobile device (110) using a position location system (114); and
a controller (210) within the mobile device (110) for receiving a position of the at least one access point from the WLAN location database (112), and for determining whether the mobile device (110) is within the at least one service area (108) of the WLAN (104) in response to the position of the mobile device (110) and the position of the at least one access point.

18. The system of claim 17, wherein the controller (210) is further configured to:
activate WLAN circuitry (214) in the mobile device (110) when the mobile device (110) is within the at least one service area (108) of the WLAN (104); and
deactivate the WLAN circuitry (214) in the mobile device (110) when the mobile device (110) is outside of the at least one service area (108) of the WLAN (104).

19. The system of claim 18, wherein the controller (210) is further configured to:
transfer communications in the mobile device (110) from the wireless communication system (102) to the WLAN (104) when the mobile device (110) is within the at least one service area (108) of the WLAN (104); and
transfer communications in the mobile device (110) from the WLAN (104) to the wireless communication system (102) when the mobile device (110) is outside of the at least one service area (108) of the WLAN (104).

20. The system of claim 18, wherein the controller (210) deactivates the WLAN circuitry (214) by at least one of:
disabling the WLAN circuitry (214) when the position of the mobile device (110) is determined to be outside of the at least one service area (108) of the WLAN (104); and
disabling the WLAN circuitry (214) in response to a decrease in signal quality received by the WLAN (104).

21. The system of claim 17, wherein the controller (210) is further configured to:
transmit the position of the mobile device (110) to the wireless communication system (102); and
receive an indication from the wireless communication system (102) when the mobile device (110) is within the at least one service area (108) of the WLAN (104).

22. The system of claim 21, wherein the controller (210) transmits the position of the mobile device (110) by at least one of:
sending the position to the wireless communication system (102) only when the mobile device (110) is communicating therewith;
sending the position to the wireless communication system (102) periodically; and
sending the position to the wireless communication system (102) in response to a specific request.

23. The system of claim 21, wherein the controller (210) receives an indication from the wireless communication system (102) only when the mobile device (110) is communicating data to the wireless communication system (102).

24. The system of claim 17, wherein the wireless communication system (102) is a cellular telephone network.
